(19) United States
(12) Patent Application Publication
(10) Pub. No.: US 2009/0012872 A1
(43) Pub. Date: Jan. 8, 2009

(54) PRICES COMPARISON SYSTEM FOR THE SECTOR OF SUPERMARKET AND RETAILER IN GENERAL IN REAL TIME

(76) Inventor: SILVIO MAUAD, SAO JOAQUIM (BR)

Correspondence Address: MCKEE, VOORHEES & SEASE, P.L.C., 801 GRAND AVENUE, SUITE 3200, DES MOINES, IA, 50309-2721, US

(21) Appl. No.: 12/137,334

(22) Filed: Jun. 11, 2008

(30) Foreign Application Priority Data
Jun. 19, 2007 (BR) PI0702802-4

(51) Int. Cl. G06Q 30/00

(52) U.S. Cl. 705/26; 705/1

(57) ABSTRACT

“PRICES COMPARISON SYSTEM FOR THE SECTOR OF SUPERMARKET AND RETAILER IN GENERAL IN REAL TIME”, notedly a system able to offer a selection of the cheaper prices and the respective commercial e/or industrial addresses to the final consumer, which stands out still for allowing an inter-activity between involved people, besides dynamism, once that offers the best prices in real time for the registered lists by the final consumer. The inter-activity also is justified by the sending of the information to the clients by e-mail, as well as alert for eventual prices reductions of registered products, without any onus.

### BACKGROUND OF THE INVENTION

The present Patent of Invention solicitation refers to a new “PRICES COMPARISON SYSTEM FOR THE SECTOR OF SUPERMARKET AND RETAILER IN GENERAL IN REAL TIME”, being particularly a system made possible by means of software that creates prices comparison tools in real time of supermarkets in certain cities, districts or regions, able to promote a purchases list with the best prices of each product, facilitating, organizing and optimizing the purchases routine of this segment that is somewhat stressful.

In the current days, the domestic planning is fundamental under all the aspects. Researches reveal that the Brazilian families, not being very different in other countries, spend about a third of their budgets in supermarket purchases. In this sense, any economy accomplished in the purchases is very welcome. It is fact that prices of a same product vary excessively of an establishment to another, some times located at the same street or neighborhood.

Thus, it is clear that the prices research before making the purchases is elemental.

However, nowadays the research as the above mentioned demand much time, not always available to the common user, in which minority access websites of the big markets to verify prices, or then they accomplish researches in the newspapers and periodic. In this hour also is worth the terrible pilgrimage to the supermarkets applicable to people with available time.

This system becomes a powerful quotation tool bringing advantages so much to the final consumer as to the commercial and/or industrial establishments.

### BRIEF SUMMARY OF THE INVENTION

With regard to the advantages for the final consumer, it can be highlighted:
Selection and offer of the better price;
effecting of concrete economic earnings;
Making available, in real time, of eventual prices oscillations;
Automatic information, via e-mail, in real time, of prices reduction of registered products;
Geographical district of the better practiced price, being for city, region, state or country;
Publicity to the better price among several commercial and/or industrial establishments that decide to announce their products;
Making possible the time optimization in the purchase, as that the selection of the best prices is a novelty in this segment;
Turning more transparent and practice the selection with the commercial and/or industrial establishments;
Integration of time economy to the purchases and the best price concomitantly;
Creation of conditions for larger effectiveness and efficiency in the planning of the purchases, with easiness for obtainment of the better price;
Free of charge, it integrates the consumer with the commercial and/or industrial establishments that announce their prices;
Reduction of spent time in the quotation of the prices;
Reduction of time to the balancing of the expense in supermarkets;
Reduction of spent time for the planning of the purchases;
Service without onus for the consumer, reflecting great cost x benefit relation.

With regard to the advantages for the commercial and/or industrial establishments, it can be highlighted:
Free of additional charge, it integrates and makes available the products to the final consumer;
Divulging addressed to the target public inside the performance sale area (city region, state and country);
Immediate divulging, free of additional charge, of the sales promotions of any products;
Divulging of the better market price is immediately accomplished and free of charge
With the offered products, it is possible to give the “link” of the consumer with the “website” of the company, commercial and/or industrial establishments that wish to sell their products directly to the final consumer, with prices divulging without any additional cost.

This system has as advantages to attribute a differentiated and specific assistance to the target public, fomenting an already consolidated market, due to the offered practicability and agilities.

### BRIEF DESCRIPTION OF THE DRAWINGS

For better illustrating the system, it follows a FIGURE representing:

FIG. 1: Flowchart showing the macro operation of the prices comparison system for the sector of supermarket and retailer in general in real time.

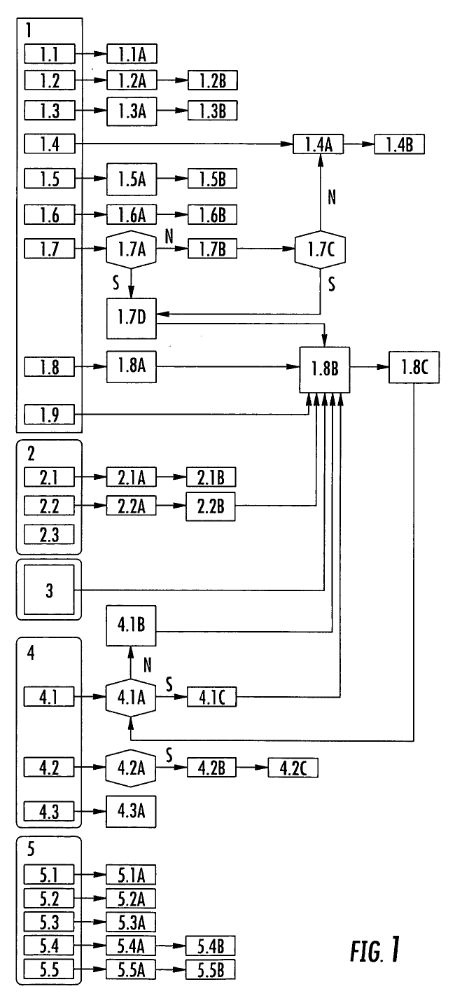

### DETAILED DESCRIPTION OF THE PREFERRED EMBODIMENT

The “PRICES COMPARISON SYSTEM FOR THE SECTOR OF SUPERMARKET AND RETAILER IN GENERAL IN REAL TIME”, notedly a system able to offer a selection of the cheaper prices and the respective commercial e/or industrial addresses to the final consumer, which stands out still for allowing an inter-activity between involved, besides dynamism once that offers the best prices in real time for the lists registered by the final consumer. The inter-activity is also justified by the sending of the information to the clients by e-mail, as well as alert to eventual prices reductions of registered products, without any onus.

The prices comparison system initiates in a first stage with the “Choice of the city”—when entering the website for the first time, the user must to choose determined city contained in a list of available cities. In this stage, beyond the cities already with the service made available, there are also the cities that will have the service make available in near future. Obviously only the available cities will be controlled by system. The selected city is the starting point for the filtration of “banners” and supermarkets information along the navigation in the “website”. In this stage, the user can, if it was the case, send a suggestion for inclusion of a city. As cities grow, the option can be extended for states and/or regions.

Once accessed, the system is divided into several menus, which make possible the navigation by means of a routine that reflects the software and consequently the resultant “website”, using resources as page in HTML; LINKS and ACTIONS originated of the interactions of the several Menus and Sub-menus.

In a logic sequence, but not compulsory, the “website” has a Superior Menu (1) with several sub-menus to initiate by sub-menu (1.1) “Who we are”, which is connected to a HTML page (1.1A), static, containing “Text relative to the page in subject”.

Second sub-menu (1.2) “Contact” is connected to a HTML page (1.2A), containing “Form with data for contact” then interlinked to an action (1.2B) “Record data in base by PHP Script”; in the contact, form is for that the users can make contact with administration of the “website”. In this form, they are listed different sectors of the “website”, so that user can direct his message.

Third sub-menu (1.3) “Announce” is connected to a HTML page (1.3A) “Form with announcement options and necessary fields for sending of marks divulgation proposals in the website” then interlinked to an action (1.3B) “Record data in bank and send e-mail by PHP Script”. In this sub-menu, it opens a page in which all users who wish to announce can verify the space availability in the “website”, and user can access the form for solicitation of the space in which should fill in the form with due data. In the case of the user be already registered, it should type “login” and password, or else it will be necessary the accomplishment of a register. Besides the referred register, user should supply and perform the necessary information for the rent of the space. In parallel, a solicitation is sent to the responsible person for the elaboration of “banners”.

Fourth sub-menu (1.4) “Register” is connected to the HTML page (1.4A) containing “Form with data for register of all kind of users of the website” then interlinked to an action (1.4B) “Record data in bank—PHP Script”. When making the register, user can manage favorite lists and pre-defined lists.

Fifth sub-menu (1.5) “News” is connected to the action (1.5A) “From the existed news on the database, a HTML page containing Links for each news that is generated in PHP Script” then interlinked to a HTML page (1.5B) which “Exhibit the news in the totality”. The news can be several news.

Sixth sub-menu (1.6) “Indicate a friend” is connected to a HTML page (1.6A) containing “Form with data to send the indication” then connected to an action (1.6B) “Send e-mail for the addressee in PHP Script”.

Seventh sub-menu (1.7) “My lists” is connected to a HTML page (1.7A) which “Ask if the user is logged”. Negative case (N), it will be redirected for other HTML page (1.7B) “Form containing field so that the user can make his logon to the system” addressed to other HTML page (1.7C) “Ask if user has register”, in negative case (N), it is redirected for the HTML page (1.4A) “Form with data for register of all kind of users of website”. Coming back to HTML page (1.7C) “Ask if user has register”, in positive case (S), it is addressed to an action (1.7D) “From existing personal lists in the database, a page containing links for each list is generated in PHP Script” redirected for other action (1.8B) “Generate result of search from chosen list (1.8); typed product (1.9); chosen brim (2.2); category/sub-category and mark (3); personal list (4.1) in PHP Script”. More specifically, with user logged, system will show his personal page, containing their defined lists and all the relative options to that personal page.

Eighth sub-menu (1.8) “Lists pre-defined” is connected to an action (1.8A) “From the existed pre-defined lists in the database, a page containing links for each list is generated in PHP Script” addressed to other action (1.8B) “Generate result of search from chosen list (1.8); typed product (1.9); chosen brim (2.2); category/sub-category and mark (3); personal list (4.1) in PHP Script”. Finally, in a last action (1.8C) “Include selected products to the products list of user in PHP Script”. Existed pre-defined lists are lists to facilitate the search of usually searched products, and to access a pre-defined list all the items will be shown.

Ninth sub-menu (1.9) “‘Search prices of’: form for research, in which user types a product and makes the research”, being that sub-menu connected to the action (1.8B) “Generate search result from chosen list (1.8); typed product (1.9); chosen brim (2.2); category/sub-category and mark (3); personal list (4.1) in PHP Script”. Through keyword typed by user system will show products met on the database.

All above mentioned sub-menus are links except sub-menu (1.9), which is a HTML page.

In the logic sequence, but not compulsory, it comes the Internal menu (2) with three sub-menus to initiate by sub-menu (2.1) “Select other city”, which is connected to the a HTML page (2.1A) containing “Form with cities and states attended by website so that the user can do the alteration” then connected to action (2.1B) “Changes user's standard city with which the information of the website will be based on PHP Script”. When clicking in this option, user will be carried to the cities selection page—beginning screen—choice of city.

Second sub-menu (2.2) “Easy list” is connected to a HTML page (2.2A) containing “Form in which user will type several products to search all at once” then interlinked to an action (2.2B) “From typed products a HTML page containing links for each product is generated. In this case, links are denominated of brims in PHP Script”, which is addressed to sub-menu (1.8B) “Generates result of search from the chosen list (1.8); typed product (1.9); chosen brim (2.2); category/sub-category and mark (3); personal list (4.1) in PHP Script”. Through of this option, user will be able to make multiple searches at the same time to facilitate the search for products.

Third sub-menu (2.3) “Where I am: report to user in which part of the website he is”. More specifically, it indicates what it is being shown at that moment.

All above mentioned sub-menus are links except sub-menu (2.3), which is a HTML page.

In the logic sequence, but not compulsory, comes the menu of sectors (3) “From the existed data on the database, they are shown all sectors, categories, sub-categories and marks of the products, existed also in database in a way of links in PHP Script”, which is addressed to sub-menu (1.8B) “Generates result of search from the chosen list (1.8); typed product (1.9); chosen brim (2.2); category/sub-category and mark (3); personal list (4.1) in PHP Script”. In this menu (3), a lateral bar appears that shows all the available sectors in the “website”. When the user opts for a sector, categories, sub-categories and marks of the products related to sector will be shown. Moreover, user will be able to come back to the sectors after having selected a certain sector, directly for this menu. That menu (3) is considered as an action.

In the logical sequence, but not compulsory, comes the lists menu (4), which will be shown when user access the page of option “Include products” or “See lists” in the hidden area “My lists”. That menu (4) presents three sub-menus to initiate by sub-menu (4.1) “My lists” that is connected to a HTML page (4.1A), which “Ask if user is logged”. Negative Case (N), it is addressed to an action (4.1B) “In case user is not logged, registered personal lists will not be available, but all products will be included in a temporary personal list in PHP Script” for then be addressed to sub-menu (1.8B) “Generate search result from chosen list (1.8); typed product (1.9); chosen brim (2.2); category/sub-category and mark (3); personal list (4.1) in PHP Script”. Thus, with user unlogged, it will be shown next information: Total of cheaper products; total by existed supermarket for city with the indication of existed products quantities of this supermarket of the chosen list. In this case, it opens a link (4.3) only of the supermarket that contains products of the selected list.

Coming back to sub-menu (4.1A) which “Ask if user is logged”, in case positive (S), it follows to an action (4.1C) “From the existed data in database all user's personal lists are shown in form of links in PHP Script” for then being addressed to sub-menu (1.8B) “Generates search result from chosen list (1.8); typed product (1.9); chosen brim (2.2); category/sub-category and mark (3); personal list (4.1) in PHP Script”. Sub-menu (4.1A) is also connected to sub-menu (1.8C) “Include selected products to the products list of user in PHP Script”.

Second sub-menu (4.2) “New List” is connected to a HTML page (4.2A) which “Ask if user is logged”. Positive Case (S), it is addressed to other HTML page (4.2B) “Form for creation of new personal list” that then is connected to an action (4.2C) “Record data in base PHP Script”.

In menus (4.1 and 4.2), in the case of user is logged, he will be able to visualize the created lists, access the products of each list, besides leaving and creating lists. When opting for a list, user will visualize the products. In this action, it will be shown following information: total of cheaper products; total of existing supermarkets for the city with the quantity indication of existing products of this supermarket in the chosen list. In this case, it opens a link (4.3) only of the supermarket that contains products of the selected list.

Third sub-menu (4.3) “Supermarkets” is connected to a HTML page (4.3A) “Page with location information and other information referred to each supermarket”. More specifically, it indicates what is being shown at that moment.

All sub-menus above mentioned are links.

In the logical sequence, but not compulsory, appears the inferior menu (5) with several sub-menus to be initiated by sub-menu (5.1) “Who we are”, which is connected to a HTML page (5.1A), static, containing “Text related to pages at issue”, just as at superior menu (1).]

Second sub-menu (5.2) “Terms of use” is connected to a HTML page (5.2A) containing “text related to page at issue” that is also a static page, with text that composes the term of use of the website.

Third sub-menu (5.3) “Privacy Policy” is connected to a HTML page (5.3A) “text related to page at issue”, being a static page with text that composes the privacy policy of the “website”.

Fourth sub-menu (5.4) “Recommend this website” is connected to a HTML page (5.4A) containing “Form with data to send the recommendation” then interlinked to an action (5.4B) “Send e-mail for the addressee by PHP Script”.

Fifth sub-menu (5.5) “News” is connected to a HTML page (5.5A) containing “Form with announcements options and necessary fields to the sending of marks proposal transmission in the website” then interlinked to an action (5.5B) “Record data in base and send e-mail by PHP Script”.

All sub-menus above mentioned are links.

This system has as main advantages to give a specific and differentiated assistance to the public in general, attributing great practicability and easiness, being a precious tool in the option for the better price of commercial and/or industrial establishments, increasing the market factor of this segment.

What is claimed is:

1. “PRICES COMPARISON SYSTEM FOR THE SECTOR OF SUPERMARKET AND RETAILER IN GENERAL IN REAL TIME”, a system able to offer a selection of the cheaper prices and the respective commercial e/or industrial addresses to the final consumer, which stands out still for allowing an inter-activity between the involved people, besides dynamism, once that offers the best prices in real time for the lists registered by the final consumer.

2. “PRICES COMPARISON SYSTEM FOR THE SECTOR OF SUPERMARKET AND RETAILER IN GENERAL IN REAL TIME”, according to claim 1; wherein it is initiated with “Choice of the city”—when entering in the website for the first time, the user must to choose determined city contained in a list of available cities.

3. “PRICES COMPARISON SYSTEM FOR THE SECTOR OF SUPERMARKET AND RETAILER IN GENERAL IN REAL TIME”, according to claim 2; wherein beyond the cities already with the available service, there are also cities that will have the service available in near future.

4. “PRICES COMPARISON SYSTEM FOR THE SECTOR OF SUPERMARKET AND RETAILER IN GENERAL IN REAL TIME”, according to claims 2 and 3; wherein operationally, the selected city is the starting point for the filtration of information and “banners” of supermarkets along the navigation of the “website”.

5. “PRICES COMPARISON SYSTEM FOR THE SECTOR OF SUPERMARKET AND RETAILER IN GENERAL IN REAL TIME”, according to claim 4; wherein, in this stage, user can, if it was the case, sending a suggestion for inclusion of a city.

6. “PRICES COMPARISON SYSTEM FOR THE SECTOR OF SUPERMARKET AND RETAILER IN GENERAL IN REAL TIME”, according to claim 5; wherein, according to growth of the cities, the option can be extended for states and/or regions.

7. “PRICES COMPARISON SYSTEM FOR THE SECTOR OF SUPERMARKET AND RETAILER IN GENERAL IN REAL TIME”, according to claim 1; wherein the system is divided into several menus, which ones make possible the navigation by means of a routine that reflects the software and consequently the resultant “website”, using resources as page in HTML; LINKS and ACTIONS originated from the interactions of the several Menus and Sub-menus.

8. “PRICES COMPARISON SYSTEM FOR THE SECTOR OF SUPERMARKET AND RETAILER IN GENERAL IN REAL TIME”, according to claims 1 and 7; wherein, in a logic sequence, but not compulsory, the “website” has a Superior Menu (1) with several sub-menus.

9. “PRICES COMPARISON SYSTEM FOR THE SECTOR OF SUPERMARKET AND RETAILER IN GENERAL IN REAL TIME”, according to claim 8; wherein it is initiated by sub-menu (1.1) “Who we are”, which is connected to a HTML page (1.1A), static, containing “Text related to pages at issue”.

10. “PRICES COMPARISON SYSTEM FOR THE SECTOR OF SUPERMARKET AND RETAILER IN GENERAL IN REAL TIME”, according to claim 8; wherein second sub-menu (1.2) “Contact” is connected to a HTML page (1.2A) containing “Form with data for contact” then interlinked to an action (1.2B) “Record data in base by PHP Script”.

11. “PRICES COMPARISON SYSTEM FOR THE SECTOR OF SUPERMARKET AND RETAILER IN GENERAL IN REAL TIME”, according to claim 10; wherein in the contact the form serve so that the users can enter in touch with the administration of the “website”.

12. “PRICES COMPARISON SYSTEM FOR THE SECTOR OF SUPERMARKET AND RETAILER IN GENERAL IN REAL TIME”, according to claim 11; wherein in this form are listed the different sectors of the “website” so that the user can direct his message.

13. “PRICES COMPARISON SYSTEM FOR THE SECTOR OF SUPERMARKET AND RETAILER IN GENERAL IN REAL TIME”, according to claim 8; wherein third sub-menu (1.3) “Announce” is connected to a HTML page (1.3A) “Form with the announcement options and necessary fields for the sending of marks proposal transmission in the website” then interlinked to an action (1.3B) “Record data in base and send e-mail by PHP Script”.

14. “PRICES COMPARISON SYSTEM FOR THE SECTOR OF SUPERMARKET AND RETAILER IN GENERAL IN REAL TIME”, according to claim 13; wherein in this sub-menu it opens a page in which all users who wish to announce can verify the space availability in the “website”, and the user can access the form for solicitation of the space, in which should perform the forms with the due data.

15. “PRICES COMPARISON SYSTEM FOR THE SECTOR OF SUPERMARKET AND RETAILER IN GENERAL IN REAL TIME”, according to claim 14; wherein in the case of the user is already registered, should type “login” and password, or else it will be necessary the accomplishment of a register.

16. “PRICES COMPARISON SYSTEM FOR THE SECTOR OF SUPERMARKET AND RETAILER IN GENERAL IN REAL TIME”, according to claim 15; wherein besides the referred register, user should supply and fill in the necessary information for rent of the space.

17. “PRICES COMPARISON SYSTEM FOR THE SECTOR OF SUPERMARKET AND RETAILER IN GENERAL IN REAL TIME”, according to claim 16; wherein in parallel a solicitation be sent to the responsible person for the elaboration of “banners”.

18. “PRICES COMPARISON SYSTEM FOR THE SECTOR OF SUPERMARKET AND RETAILER IN GENERAL IN REAL TIME”, according to claim 8; wherein the fourth sub-menu (1.4) “Register” is connected to a HTML page (1.4A) containing “Form with data for the register of all kind of users of the website” then interlinked to an action (1.4B) “Record data in base by PHP Script”.

19. “PRICES COMPARISON SYSTEM FOR THE SECTOR OF SUPERMARKET AND RETAILER IN GENERAL IN REAL TIME”, according to claim 18; wherein when registered, user can manage favorite lists and pre-defined lists.

20. “PRICES COMPARISON SYSTEM FOR THE SECTOR OF SUPERMARKET AND RETAILER IN GENERAL IN REAL TIME”, according to claim 8; wherein the fifth sub-menu (1.5) “News” is connected to an action (1.5A) “From the existed news on the database, a HTML page containing Links for each news is generated in PHP Script” then interlinked to a HTML page (1.5B) which “Exhibition the news in the totality”.

21. “PRICES COMPARISON SYSTEM FOR THE SECTOR OF SUPERMARKET AND RETAILER IN GENERAL IN REAL TIME”, according to claim 20; wherein it can be several news.

22. “PRICES COMPARISON SYSTEM FOR THE SECTOR OF SUPERMARKET AND RETAILER IN GENERAL IN REAL TIME”, according to claim 8; wherein sixth sub-menu (1.6) “Indicate a friend” is connected to a HTML page (1.6A) containing “Form with data to send the indication” then connected to an action (1.6B) “Send e-mail for the addressee in PHP Script”.

23. “PRICES COMPARISON SYSTEM FOR THE SECTOR OF SUPERMARKET AND RETAILER IN GENERAL IN REAL TIME”, according to claim 8; wherein seventh sub-menu (1.7) “My lists” is connected to a HTML page (1.7A) which “Ask if user is logged”.

24. “PRICES COMPARISON SYSTEM FOR THE SECTOR OF SUPERMARKET AND RETAILER IN GENERAL IN REAL TIME”, according to claim 23; wherein in Negative case (N), it is redirected for other HTML page (1.7B) “Form containing field so that user can make his logon to the system” addressed to other HTML page (1.7C) “Ask if user has register”, in negative case (N), it is redirected for the HTML page (1.4A) “Form with data for register of all kind of users of the website”.

25. “PRICES COMPARISON SYSTEM FOR THE SECTOR OF SUPERMARKET AND RETAILER IN GENERAL IN REAL TIME”, according to claim 23; wherein coming back to HTML page (1.7C) “Ask if user has register”, in positive case (S), it is addressed to an action (1.7D) “From the existed personal lists on the database, a page containing links for each list is generated in PHP Script” redirected for other action (1.8B) “Generate result of search from the chosen list (1.8); typed product (1.9); chosen brim (2.2); category/sub-category and mark (3); personal list (4.1) in PHP Script”.

26. “PRICES COMPARISON SYSTEM FOR THE SECTOR OF SUPERMARKET AND RETAILER IN GENERAL IN REAL TIME”, according to claim 23; wherein when user is logged, the system will show his personal page, containing his defined lists and all options related to that personal page.

27. “PRICES COMPARISON SYSTEM FOR THE SECTOR OF SUPERMARKET AND RETAILER IN GENERAL IN REAL TIME”, according to claim 8; wherein eighth sub-menu (1.8) “Pre-defined lists” is connected to an action (1.8A) “From the pre-defined lists existed on the database, a page containing links for each list is generated in PHP Script” addressed to other action (1.8B) “Generate result of search from the chosen list (1.8); typed product (1.9); chosen brim (2.2); category/sub-category and mark (3); personal list (4.1) in PHP Script”; in a last action (1.8C) “Include products selected to the products list of user in PHP Script”.

28. “PRICES COMPARISON SYSTEM FOR THE SECTOR OF SUPERMARKET AND RETAILER IN GENERAL IN REAL TIME”, according to claim 27; wherein pre-defined lists are existed lists to facilitate the search of usually searched products, and to the access a pre-defined list, all items will be shown.

29. “PRICES COMPARISON SYSTEM FOR THE SECTOR OF SUPERMARKET AND RETAILER IN GENERAL IN REAL TIME”, according to claim 8; wherein ninth sub-menu (1.9) “Search prices of: form for research, in which user types a product and makes the research”, being that sub-menu connected to the action (1.8B) “Generate result of search from the chosen list (1.8); typed product (1.9); chosen brim (2.2); category/sub-category and mark (3); personal list (4.1) in PHP Script”.

30. “PRICES COMPARISON SYSTEM FOR THE SECTOR OF SUPERMARKET AND RETAILER IN GENERAL IN REAL TIME”, according to claim 29; wherein through the word key typed by the user the system show the products met on the bench of data.

31. “PRICES COMPARISON SYSTEM FOR THE SECTOR OF SUPERMARKET AND RETAILER IN GENERAL IN REAL TIME”, according to claim 8; wherein all sub-menus above mentioned are links except sub-menu (1.9), which is a HTML page.

32. “PRICES COMPARISON SYSTEM FOR THE SECTOR OF SUPERMARKET AND RETAILER IN GENERAL IN REAL TIME”, according to claims 1 and 7 wherein in a logical sequence, but not compulsory, “website” has an Internal menu (2) with three sub-menus.

33. “PRICES COMPARISON SYSTEM FOR THE SECTOR OF SUPERMARKET AND RETAILER IN GENERAL IN REAL TIME”, according to claim 32; wherein it is initiated by sub-menu (2.1) “Select other city”, which is connected to a HTML page (2.1A) containing “Form with cities and states attended by the website, so that user can do the alteration” then connected to the action (2.1B) “Changes the city user's standard with which the information of the website will be based on PHP Script”.

34. “PRICES COMPARISON SYSTEM FOR THE SECTOR OF SUPERMARKET AND RETAILER IN GENERAL IN REAL TIME”, according to claim 33; wherein when this option is clicked, user is taken to the cities selection page—beginning screen—choice of city.

35. “PRICES COMPARISON SYSTEM FOR THE SECTOR OF SUPERMARKET AND RETAILER IN GENERAL IN REAL TIME”, according to claim 32; wherein second sub-menu (2.2) “Easy list” is connected to a HTML page (2.2A) containing “Form in which the user will type several products to search all at once” then interlinked to an action (2.2B) “From the typed products, a HTML page containing the links for each product is generated”.

36. “PRICES COMPARISON SYSTEM FOR THE SECTOR OF SUPERMARKET AND RETAILER IN GENERAL IN REAL TIME”, according to claim 35; wherein in this case the links are denominated of brims in PHP Script, which is addressed to sub-menu (1.8B) “Generates result of search from the chosen list (1.8); typed product (1.9); chosen brim (2.2); category/sub-category and mark (3); personal list (4.1) in PHP Script”.

37. “PRICES COMPARISON SYSTEM FOR THE SECTOR OF SUPERMARKET AND RETAILER IN GENERAL IN REAL TIME”, according to claim 36; wherein through of this option the user can make multiple searches at the same time to facilitate the search for products.

38. “PRICES COMPARISON SYSTEM FOR THE SECTOR OF SUPERMARKET AND RETAILER IN GENERAL IN REAL TIME”, according to claim 32; wherein the third sub-menu is (2.3) “Where I am: report to the user in which part of the website he is in”.

39. “PRICES COMPARISON SYSTEM FOR THE SECTOR OF SUPERMARKET AND RETAILER IN GENERAL IN REAL TIME”, according to claim 38; wherein it is indicated what it is being shown at moment.

40. “PRICES COMPARISON SYSTEM FOR THE SECTOR OF SUPERMARKET AND RETAILER IN GENERAL IN REAL TIME”, according to claim 32; wherein all sub-menus above mentioned are links except sub-menu (2.3) which is a HTML page.

41. “PRICES COMPARISON SYSTEM FOR THE SECTOR OF SUPERMARKET AND RETAILER IN GENERAL IN REAL TIME”, according to claims 1 and 7, wherein in a logic sequence, but not compulsory appears the menu of sectors (3) “From the existed data on the database, it is shown all sectors, categories, sub-categories and marks of the products, existed also in database in links form in PHP Script” which is addressed to sub-menu (1.8B) “Generate result of search from the chosen list (1.8); typed product (1.9); chosen brim (2.2); category/sub-category and mark (3); personal list (4.1) in PHP Script”.

42. “PRICES COMPARISON SYSTEM FOR THE SECTOR OF SUPERMARKET AND RETAILER IN GENERAL IN REAL TIME”, according to claim 41; wherein in this menu (3), it appears a lateral bar, which shows all the available sectors in the “website”.

43. “PRICES COMPARISON SYSTEM FOR THE SECTOR OF SUPERMARKET AND RETAILER IN GENERAL IN REAL TIME”, according to claim 42; wherein when the user opts for a sector, the categories, sub-categories and marks of the products related to sector will be shown.

44. “PRICES COMPARISON SYSTEM FOR THE SECTOR OF SUPERMARKET AND RETAILER IN GENERAL IN REAL TIME”, according to claim 43; wherein the user to come back to the sectors after have selected a certain sector, directly for this menu.

45. “PRICES COMPARISON SYSTEM FOR THE SECTOR OF SUPERMARKET AND RETAILER IN GENERAL IN REAL TIME”, according to claim 41; wherein that menu (3) is considered as an action.

46. “PRICES COMPARISON SYSTEM FOR THE SECTOR OF SUPERMARKET AND RETAILER IN GENERAL IN REAL TIME”, according to claims 1 and 7; wherein in a logic sequence, but not compulsory, it comes the lists menu (4) which will be shown when user access the page of the option “Include products” or “See lists” in the hidden area “my lists”.

47. “PRICES COMPARISON SYSTEM FOR THE SECTOR OF SUPERMARKET AND RETAILER IN GENERAL IN REAL TIME”, according to claim 46; wherein the menu (4) presents three sub-menus.

48. “PRICES COMPARISON SYSTEM FOR THE SECTOR OF SUPERMARKET AND RETAILER IN GENERAL IN REAL TIME”, according to claim 47; wherein it is initiated by sub-menu (4.1) “My lists” that is connected to a HTML page (4.1A) which “Ask if the user is logged”.

49. “PRICES COMPARISON SYSTEM FOR THE SECTOR OF SUPERMARKET AND RETAILER IN GENERAL IN REAL TIME”, according to claim 48; wherein in negative case (N), it is addressed to an action (4.1B) “In case the user is not logged, the registered personal lists will not be available, but all the products will be included in a temporary personal list in PHP Script” for then be addressed to sub-menu (1.8B) “Generates result of search from the chosen list (1.8); typed product (1.9); chosen brim (2.2); category/sub-category and mark (3); personal list (4.1) in PHP Script”.

50. “PRICES COMPARISON SYSTEM FOR THE SECTOR OF SUPERMARKET AND RETAILER IN GENERAL IN REAL TIME”, according to claim 49; wherein with the user unlogged, it is shown next information: Total of cheaper products; total by existed supermarket for the city with the quantities indication of existed products of this supermarket of the chosen list.

51. “PRICES COMPARISON SYSTEM FOR THE SECTOR OF SUPERMARKET AND RETAILER IN GENERAL IN REAL TIME”, according to claim 50; wherein in this case, it opens a link (4.3) only of the supermarket that contains products of the selected list.

52. “PRICES COMPARISON SYSTEM FOR THE SECTOR OF SUPERMARKET AND RETAILER IN GENERAL IN REAL TIME”, according to claim 48; wherein it comes back to sub-menu (4.1A), which “Ask if the user is logged”, in case positive (S), it follows to an action (4.1C) “From the existed data in database all user's personal lists are shown in links form in PHP Script” for then be addressed to sub-menu (1.8B) “Generates result of search from the chosen list (1.8); typed product (1.9); chosen brim (2.2); category/sub-category and mark (3); personal list (4.1) in PHP Script”.

53. “PRICES COMPARISON SYSTEM FOR THE SECTOR OF SUPERMARKET AND RETAILER IN GENERAL IN REAL TIME”, according to claim 52; wherein the sub-menu (4.1A) is also connected to sub-menu (1.8C) “Include selected products to the products list of the user in PHP Script”.

54. “PRICES COMPARISON SYSTEM FOR THE SECTOR OF SUPERMARKET AND RETAILER IN GENERAL IN REAL TIME”, according to claim 47; wherein second sub-menu (4.2) “New List” is connected to a HTML page (4.2A), which “Ask if user is logged”.

55. “PRICES COMPARISON SYSTEM FOR THE SECTOR OF SUPERMARKET AND RETAILER IN GENERAL IN REAL TIME”, according to claim 54; wherein in positive case (S), it is addressed to other HTML page (4.2B) “Form for creation of new personal list” that then is connected to an action (4.2C) “Record data in support PHP Script”.

56. “PRICES COMPARISON SYSTEM FOR THE SECTOR OF SUPERMARKET AND RETAILER IN GENERAL IN REAL TIME”, according to claim 47; wherein in the menus (4.1 and 4.2), in the case of the user is logged, it will be able to visualize the maid lists, access the products of each list, besides leaving and creating lists.

57. “PRICES COMPARISON SYSTEM FOR THE SECTOR OF SUPERMARKET AND RETAILER IN GENERAL IN REAL TIME”, according to claim 56; wherein when opting for a list, user visualizes the products.

58. “PRICES COMPARISON SYSTEM FOR THE SECTOR OF SUPERMARKET AND RETAILER IN GENERAL IN REAL TIME”, according to claim 57; wherein in this action, it is shown next information: total of cheaper products; total of existed supermarkets by city with the quantity indication of existed products of this supermarket in the chosen list.

59. “PRICES COMPARISON SYSTEM FOR THE SECTOR OF SUPERMARKET AND RETAILER IN GENERAL IN REAL TIME”, according to claim 58; wherein in this case, it opens a link (4.3) only of the supermarket that contains products of the selected list.

60. “PRICES COMPARISON SYSTEM FOR THE SECTOR OF SUPERMARKET AND RETAILER IN GENERAL IN REAL TIME”, according to claim 47; wherein the third sub-menu (4.3) “Supermarkets” is connected to a HTML page (4.3A) “Page with location information and other referred information to each supermarket”.

61. “PRICES COMPARISON SYSTEM FOR THE SECTOR OF SUPERMARKET AND RETAILER IN GENERAL IN REAL TIME”, according to claim 60; wherein it is indicated what it is being shown at moment.

62. “PRICES COMPARISON SYSTEM FOR THE SECTOR OF SUPERMARKET AND RETAILER IN GENERAL IN REAL TIME”, according to claim 47; wherein all sub-menus above mentioned are links.

63. “PRICES COMPARISON SYSTEM FOR THE SECTOR OF SUPERMARKET AND RETAILER IN GENERAL IN REAL TIME”, according to claims 1 and 7; wherein in a logic sequence, but not compulsory, the inferior menu (5) presents several sub-menus.

64. “PRICES COMPARISON SYSTEM FOR THE SECTOR OF SUPERMARKET AND RETAILER IN GENERAL IN REAL TIME”, according to claim 63; wherein it is initiated by sub-menu (5.1) “Who we are”, which is connected to a HTML page (5.1A), static, containing “Text related to the pages at issue”.

65. “PRICES COMPARISON SYSTEM FOR THE SECTOR OF SUPERMARKET AND RETAILER IN GENERAL IN REAL TIME”, according to claim 63; wherein second sub-menu (5.2) “Terms of use” is connected to a HTML page (5.2A) containing “text related to the page at issue”.

66. “PRICES COMPARISON SYSTEM FOR THE SECTOR OF SUPERMARKET AND RETAILER IN GENERAL IN REAL TIME”, according to claim 65; wherein it is a static page with text that composes the term of use of the website.

67. “PRICES COMPARISON SYSTEM FOR THE SECTOR OF SUPERMARKET AND RETAILER IN GENERAL IN REAL TIME”, according to claim 63; wherein third sub-menu (5.3) “Privacy Policy” is connected to a HTML page (5.3A) “text relative to the page at issue”.

68. “PRICES COMPARISON SYSTEM FOR THE SECTOR OF SUPERMARKET AND RETAILER IN GENERAL IN REAL TIME”, according to claim 67; wherein it is a static page with text that composes the privacy policy of the “website”.

69. “PRICES COMPARISON SYSTEM FOR THE SECTOR OF SUPERMARKET AND RETAILER IN GENERAL IN REAL TIME”, according to claim 63; wherein fourth sub-menu (5.4) “Recommend this website” is connected to the a HTML page (5.4A) containing “Form with data to send the recommendation” then interlinked to an action (5.4B) “Send e-mail for the addressee by PHP Script”.

70. “PRICES COMPARISON SYSTEM FOR THE SECTOR OF SUPERMARKET AND RETAILER IN GENERAL IN REAL TIME”, according to claim 63; wherein fifth sub-menu (5.5) “News” is connected to a HTML page (5.5A) containing “Form with the announcements options and necessary fields to the sending of the marks proposal transmission in the website” then interlinked to an action (5.5B) “Record data in base and send e-mail by PHP Script”.

71. “PRICES COMPARISON SYSTEM FOR THE SECTOR OF SUPERMARKET AND RETAILER IN GENERAL IN REAL TIME”, according to claim 63; wherein all sub-menus above mentioned are links.
